(19) United States
(12) Patent Application Publication
(10) Pub. No.: US 2001/0023410 A1
(43) Pub. Date: Sep. 20, 2001

(54) Agricultural product business system

(76) Inventors: Alice Hayes, West Linn, OR (US); Mark Hayes, West Linn, OR (US); Rolf Kraus, Beaverton, OR (US)

Correspondence Address: Eugene C. Rzucidlo, Esq., Greenberg Traurig, LLp, 22nd Floor, 885 Third Avenue, New York, NY, 10022, US

(21) Appl. No.: 09/779,378

(22) Filed: Feb. 7, 2001

Related U.S. Application Data
(60) Provisional application No. 60/180,897, filed on Feb. 7, 2000.

(51) Int. Cl. G06F 17/60

(52) U.S. Cl. 705/26

(57) ABSTRACT

An agricultural product business system includes a software portion installed and executable by a system server connected to the Internet. The system is configured to communicate with consumers and growers operating remote terminals connected to the Internet. A system administrator may also access the system via a remote terminal connected to the Internet or via a terminal connected to the system server. The system is configured to provide a distinct interface for communications with each type of user: consumer, grower, or administrator.

### CROSS REFERENCE TO RELATED APPLICATIONS

This application claims priority to U.S. Provisional Patent Application Serial No. 60/180,897, filed Feb. 7, 2000, and entitled AGRICULTURAL PRODUCT BUSINESS SYSTEM.

### DESCRIPTION OF THE INVENTION

The invention is a computer-implemented system and method for receiving orders for agricultural products and selectively distributing those orders to a network of agricultural product suppliers such as growers. The system may be implemented in a variety of ways within the scope of the invention. In an exemplary embodiment described below, at least a portion of the system is implemented as an automated, electronic-commerce system (or subsystem) configured to receive orders from buyers via the Internet (or communication network), and to selectively distribute those orders to the network of growers via the Internet.

The exemplary embodiment of the system includes a software portion installed and executable by a system server connected to the Internet. The system is configured to communicate with consumers and growers operating remote terminals connected to the Internet. A system administrator may also access the system via a remote terminal connected to the Internet or via a terminal connected to the system server. Typically, the system is configured to provide a distinct interface for communications with each type of user: consumer, grower, or administrator.

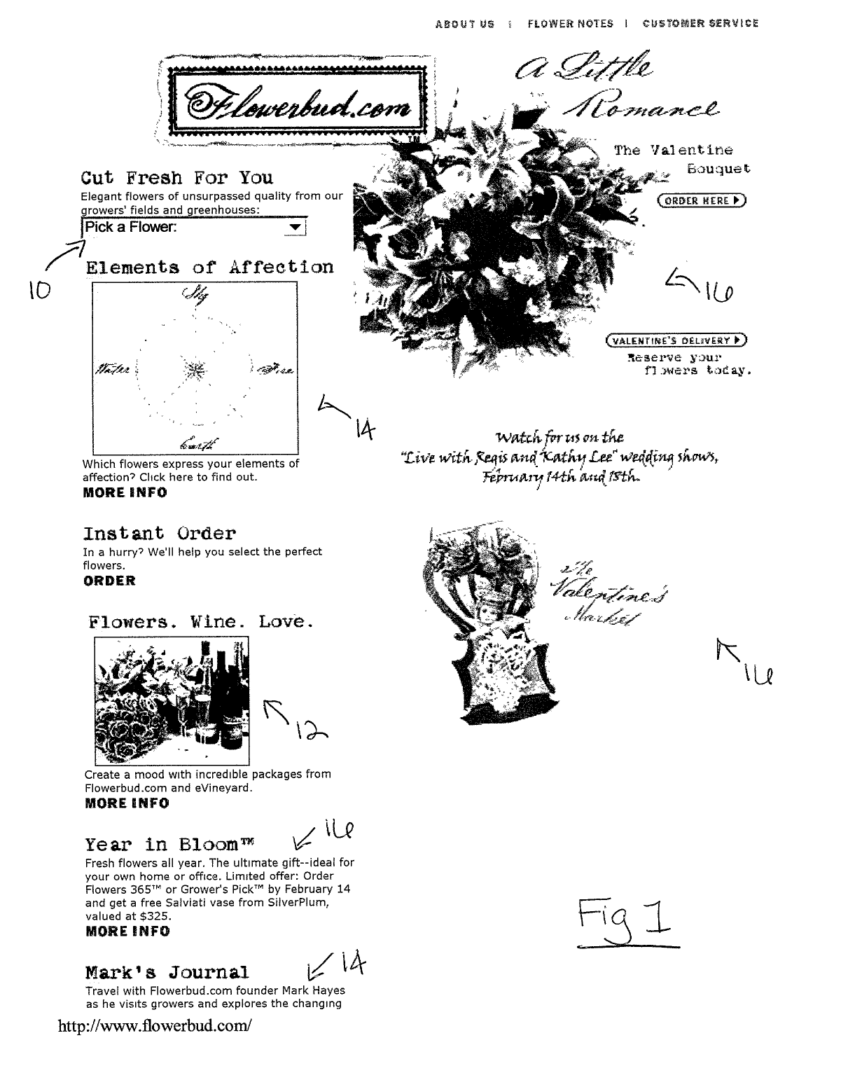

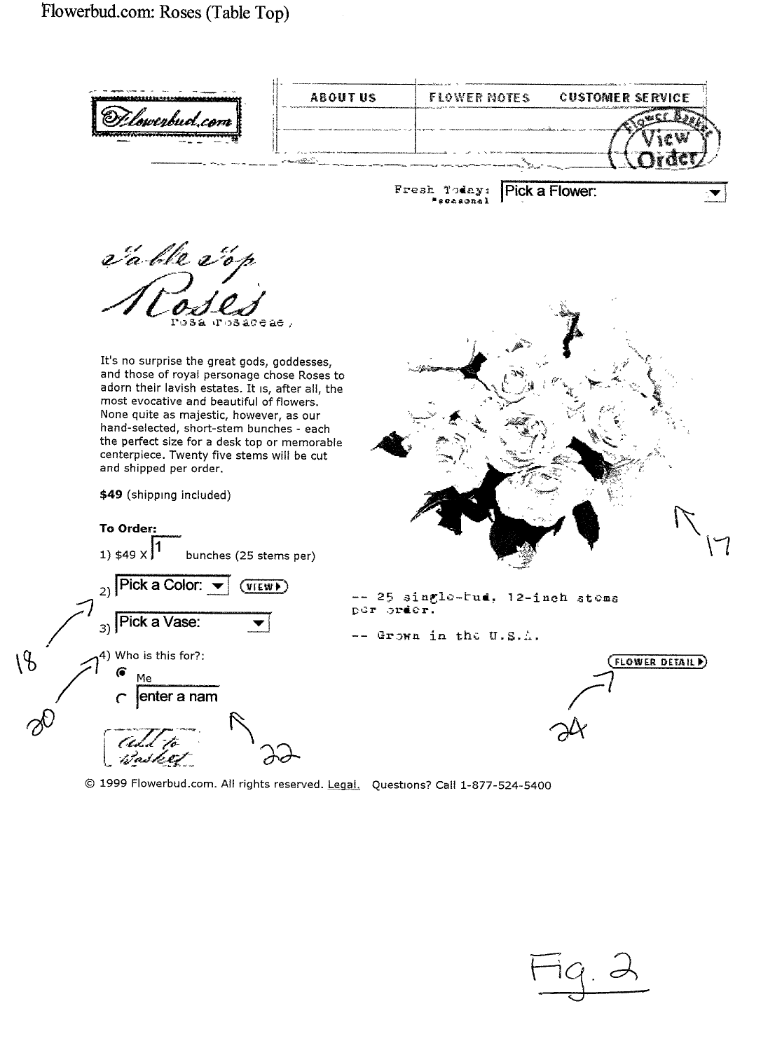

The user interface provided by the exemplary system may include any one or combination of a variety of features for selecting and purchasing agricultural products. In illustration, FIGS. 1-5C depict the consumer interface of an exemplary implementation of the system configured to sell flowers via the Internet. FIG. 1 shows an exemplary Internet “home” web page where a consumer may begin the flower shopping transaction. The web page includes a pull-down menu of flowers 10 by which a consumer may review the flowers available for purchase. The home page may also include hypertext links to other consumer resources such as related products available for purchase 12, general information on flowers 14, special offers and advertisements 16, etc.

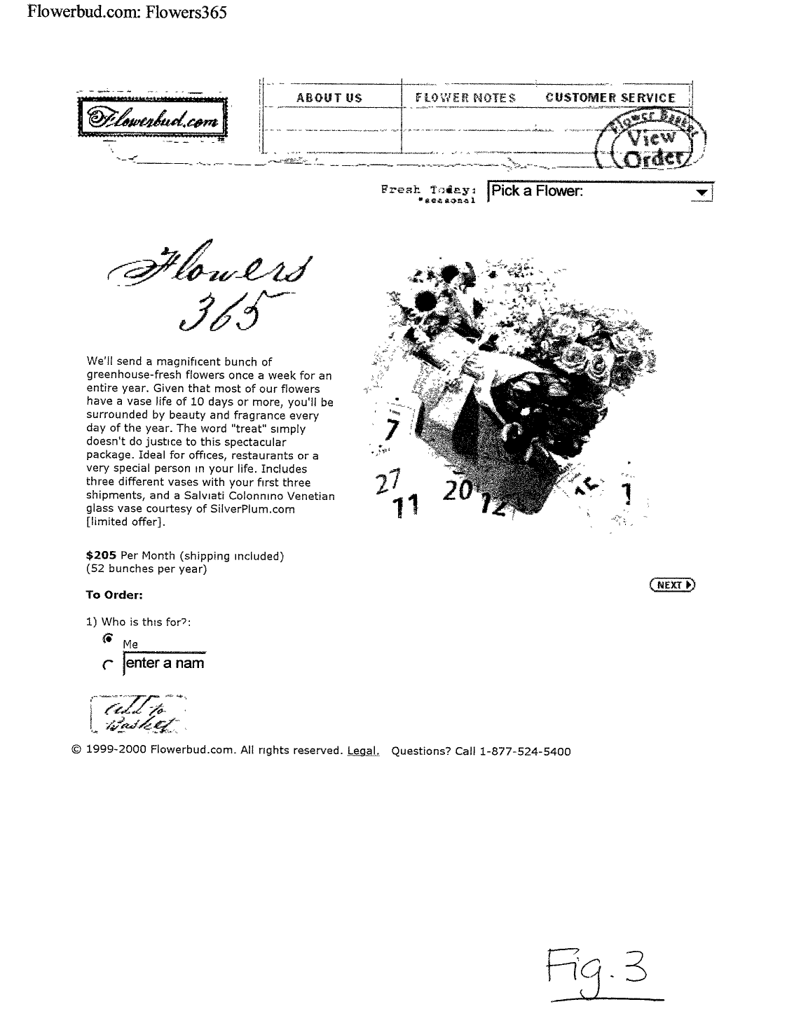

Using the interface, a consumer may shop for a particular flower by selecting it from the pull-down menu. The system then responds with a web page specific to the selected flower, as shown in FIG. 2. The specific flower web page includes general information specific to the selected flower, as well as an image 17 of the flower. A pull-down menu 18 may be provided to allow the consumer to select a particular feature of the flower such as color, etc. Once the consumer selects the desired feature(s), image 17 may be updated to show a flower with the selected features. Typically, another pull-down menu 20 may be provided to allow the consumer to select from a list of available vases or to select not to purchase a vase. One or more data entry fields 22 may be provided to allow the consumer to specify the recipient of the flowers purchased. A details link 24 provides the consumer with additional information about the selected flower.

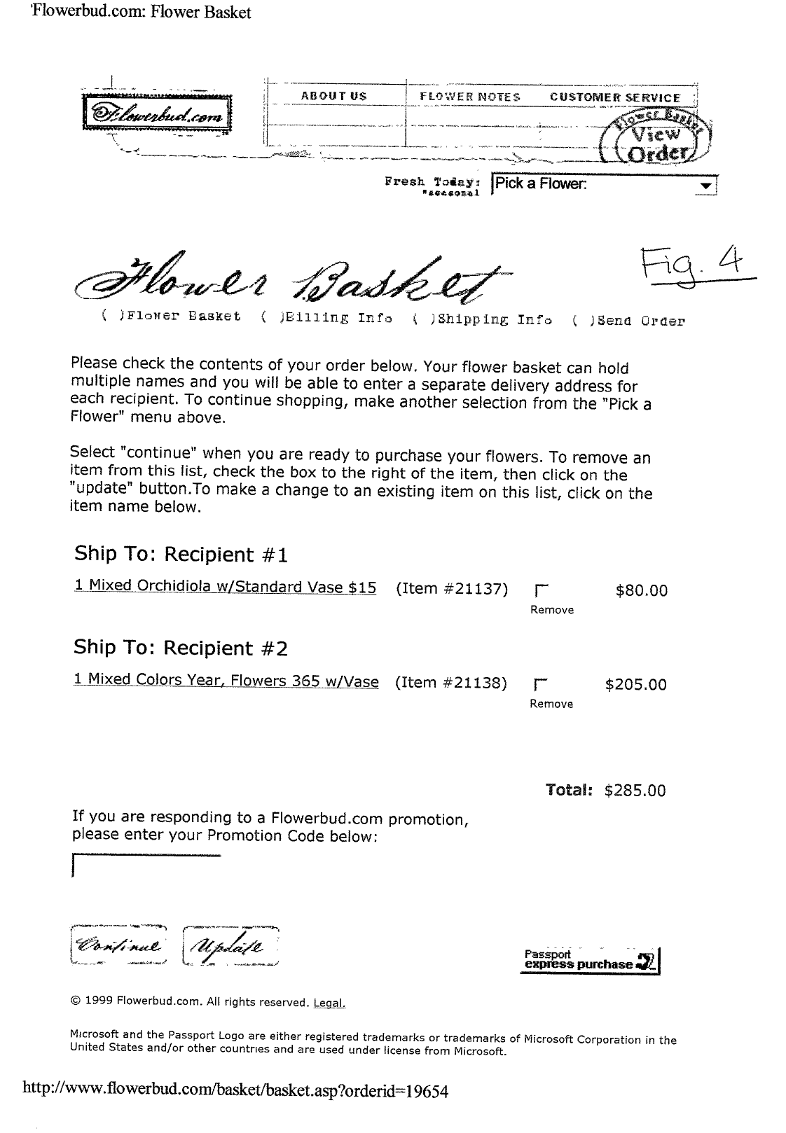

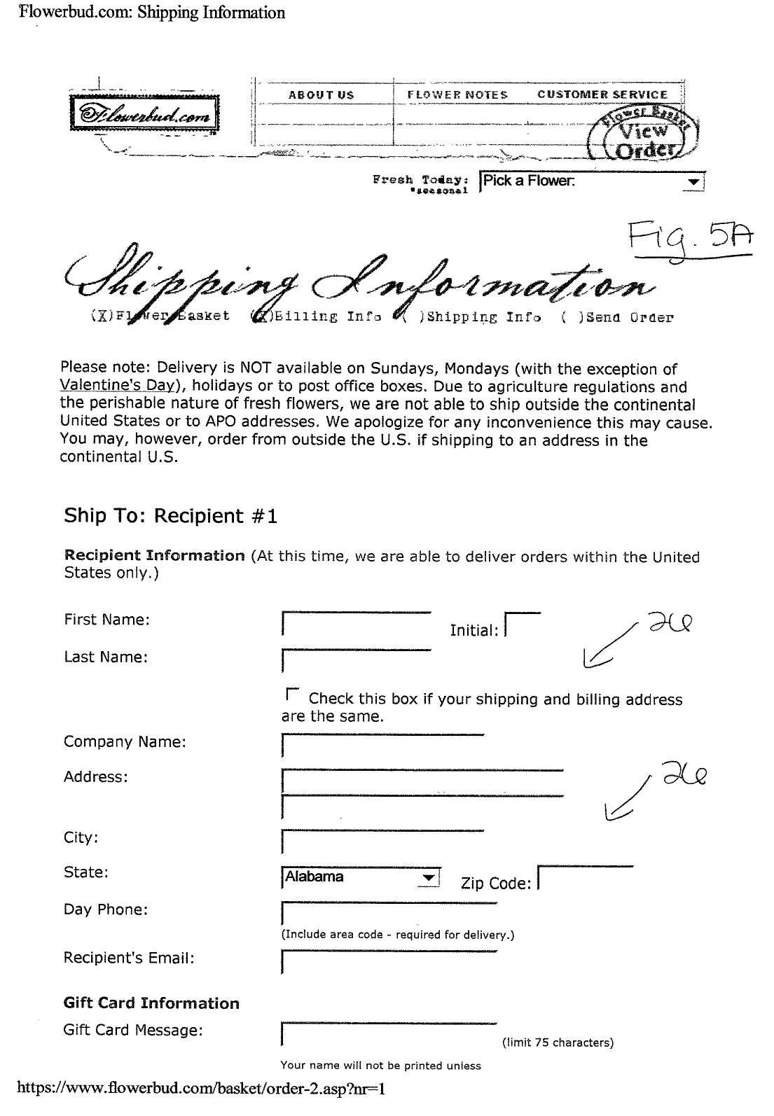

In addition to allowing the consumer to place a single order for flowers, FIG. 3 illustrates an exemplary web page from which the consumer may order flowers for automatic delivery on a periodic basis such as once per week, month, etc. The system is configured to store the order and automatically repeat execution of the order on the selected periodic basis.

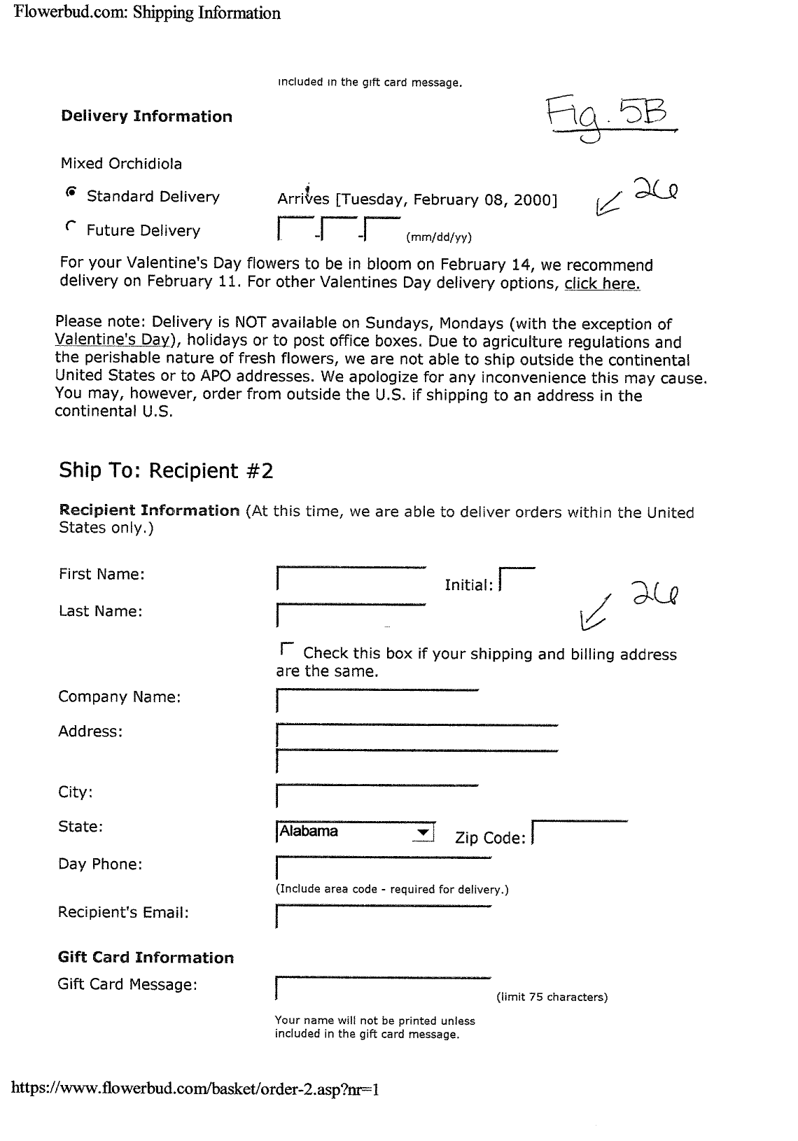

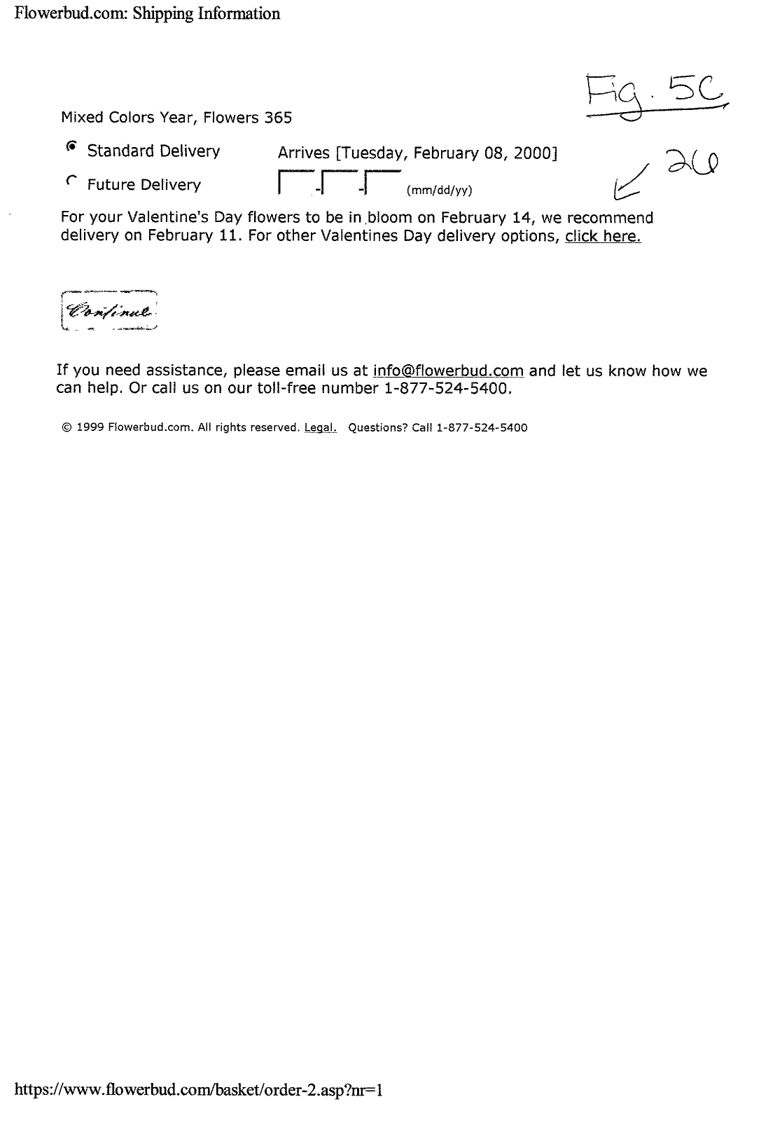

According to one embodiment of the invention, a consumer may make multiple purchases during a single shopping transaction, and have the purchases sent to multiple locations. This embodiment is illustrated in FIG. 4, which shows the consumer's “flower basket” containing the flowers selected for purchase and indicating shipment to multiple recipients. Once the consumer confirms the selections, the system responds with a shipping web page illustrated in FIGS. 5A-5C. The consumer may specify where the flowers should be delivered by entering the appropriate information into the data entry fields 26 on the shipping web page. The consumer may also specify whether the flowers should be delivered immediately or on some future date.

Typically the consumer completes the purchase transaction by entering appropriate payment authorization. The system then executes the order by automatically transmitting it to one or more of multiple flower growers depending on a variety of factors. Upon receipt of the order, the growers package the selected flowers and ship them to the recipients specified by the consumer. However, the flowers are shipped under a single label associated with the ordering system so that the network of independent growers appear as a single, reliable source to the consumer. By linking the independent growers under a single brand in a way that is transparent to the consumers, the growers can realize the benefit of combined brand loyalty and recognition based on sales of multiple growers across a region. In addition, the system can provide consumers with a single source which is capable of supplying fresh flowers of such diversity and quantity as would be virtually impossible for a single grower.

It will be appreciated that there are a variety of ways in which the system may be configured to distribute and allocate consumer order to the network of growers. In one exemplary embodiment, the administrator interface is configured to allow the system administrator to manage the flow of orders from a remote terminal. The system, orders and administrative information is stored on a database which also is managed through the administrator interface.

Through the interface, the administrator enters products (e.g., roses, tulips, bouquets, etc.), then for each product the administrator selects a distributor/grower, a priority for that grower, a daily maximum quantity, a percentage of the product that goes to the grower and a percentage that applies to the daily maximum. Once product sales reach the number that is the percentage of the daily quota, the system communicates a message to the administrator. Orders are associated with a specific grower based on information entered by the administrator. If there is only one grower in the network for a particular product, then all orders for the product will be sent to that grower. If there is more than one grower, orders are distributed based on the percent distribution associated with the product and grower. Alternatively, if the daily quota is met with the priority 1 grower, orders are then sent to the priority 2 grower.

Once products are in the database and associated with a specific grower the administrator may change the grower in one of several ways. For example, the administrator can redirect orders that have not been received. In effect, this is a one-day change to the priority of the grower.

For example, if on a particular day grower A does not have orange lilies, the administrator can direct orders for orange lilies to grower B. On the next day, the new orders will revert to grower A (in order to make a longer-term change, the administrator changes the grower's priority).

After an order is received but before a grower prints shipping information, the administrator can cancel the order to that grower and redirect orders to alternate growers on that product list. After the label has been printed, the label can be voided and the administrator can then redirect the order to an alternate grower.

In addition, the administrator interface allows the administrator to find and change most customer-input information about an order, i.e. shipping date and address, actual item, gift message, etc.

As mentioned above, the grower interface is also accessible through the system server via the Internet.

Growers access their specific order and quota information by entering a user name and password. Then they can access new orders. They have a list of all orders for the current day and for future days, allowing the growers to plan their shipments in advance. The grower interface also provides a shipping label generation function allowing the growers to automatically print shipping labels for each consumer order. The system also allows the grower to print out the gift card (if any) specified by the consumer for inclusion in the shipment. Each individual order is printed out on a single form including shipping tracking codes, etc. For example, the shipping label may be a UPS approved label generated by the system interfaced with Aristo software. The tracking numbers are assigned by the system and then sent to UPS electronically when a grower closes the day.

After the grower has packed the orders and know they can fill them all, they access the system via the interface to close the day. If they could not fill an order, interface allows them to void an order, in which case the order is returned to the administrator to be redirected to another grower.

Through the grower interface the growers can also request a change in their daily quotas, request supplies and review the grower administration/instruction manual.

We claim:

1. An agricultural business product system, usable by system users and by a system administrator to manage plural product orders, comprising:
an automated, electronic-commerce subsystem configured to receive orders from buyers via a communication network, and to selectively distribute those orders to the network of growers via the Internet.

2. The system of claim 1, wherein the subsystem includes a software portion installed and executable by a system server connected to the communication network.

3. The system of claim 2, further including a database that contains the system, orders and administrative information; and an administrator interface configured to allow a system administrator to manage the orders from a remote terminal and to manage the database.

4. The system of claim 3, further including a distinct interface for communications with different types of users.
